(19) United States
(12) Patent Application Publication
(10) Pub. No.: US 2017/0373522 A1
(43) Pub. Date: Dec. 28, 2017

(54) Charging System

(71) Applicant: Apple Inc., Cupertino, CA (US)

(72) Inventors: Alessandro Pelosi, San Jose, CA (US); Thomas Sherman, Sunnyvale, CA (US); James C. Murphy, San Jose, CA (US)

(21) Appl. No.: 15/619,315

(22) Filed: Jun. 9, 2017

Related U.S. Application Data
(60) Provisional application No. 62/354,025, filed on Jun. 23, 2016.

(51) Int. Cl. H02J 7/02; H02J 7/00; H04B 5/00

(52) U.S. Cl. CPC H02J 7/025; H04B 5/0037; H02J 7/0021; H04B 5/0031; H02J 2007/0096

(57) ABSTRACT

A system may have a power adapter with multiple ports for supplying power to electronic devices. The electronic devices may include devices such as cellular telephones, wristwatch devices, laptop computers, and tablet computers. The power adapter may supply power using wired links and wireless links. An online user account that is maintained on computing equipment in the system can communicate with the electronic devices or power adapter over a communications network. The power adapter and other components of the system may gather information such as user device charging priority settings, battery charge state information, device type information, usage history information, calendar information, and other information. This gathered information may be used in identifying an optimum power transfer strategy for the power adapter to use in transmitting different amounts of power to each of the electronic devices.

This application claims the benefit of provisional patent application No. 62/354,025, filed Jun. 23, 2016, which is hereby incorporated by reference herein in its entirety.

### BACKGROUND

This relates generally to charging systems, and, more particularly, to systems for charging electronic devices.

Electronic devices often include batteries. A power adapter may be used to convert alternating current power into direct current power. Direct current power from a power adapter or a battery can be conveyed to electronic devices that are coupled to the power adapter using cables. Power may also be transmitted wirelessly. An electronic device that receives wired or wireless power may use the received power to operate circuitry in the electronic device and to charge a battery in the electronic device.

Power adapters have limited capabilities, which can make it difficult for a single power adapter to charge multiple devices. If multiple devices are plugged into a power adapter that has multiple ports, the power adapter may be overloaded and devices may not receive desired amounts of power. As a result, charging times may be longer than desired and devices with critically low battery levels may not be recharged in a timely fashion. Many power adapters are not even able to supply power to multiple devices simultaneously.

### SUMMARY

It would therefore be desirable to be able to provide improved power adapters for providing power to electronic devices.

A system may have a power adapter with multiple ports for supplying power to respective electronic devices. The electronic devices may include devices such as cellular telephones, wristwatch devices, laptop computers, and tablet computers. The power adapter may supply power to the electronic devices using wired links and wireless links.

An online user account may be maintained on computing equipment in the system. The computing equipment may communicate with the electronic devices or power adapter over a communications network. The power adapter or other components in the system may gather information from the online account, from the electronic devices, and/or from the power adapter to use in identifying an optimum power transfer strategy for the power adapter to use in transferring power to each of the electronic devices. The optimum power transfer strategy may involve transmitting different amounts of power to different electronic devices.

The information that is used in identifying appropriate amounts of power to transmit to each of the electronic devices may include information such as user device charging priority settings, battery charge state information, device type information, usage history information, calendar information, and other information.

### BRIEF DESCRIPTION OF THE DRAWINGS

FIG. 1 is a schematic diagram of an illustrative system that includes a power adapter and electronic devices that receive power from the power adapter in accordance with an embodiment.

FIG. 2 is a schematic diagram of an illustrative power adapter having circuitry that provides wired power to an electronic device in accordance with an embodiment.

FIG. 3 is a schematic diagram of an illustrative power adapter having circuitry that provides wireless power to an electronic device in accordance with an embodiment.

FIG. 4 is a flow chart of illustrative steps involved in identifying and using optimum power transfer settings to supply power to electronic devices from a power adapter in accordance with an embodiment.

### DETAILED DESCRIPTION

Equipment such as a power adapter may be used to supply power to multiple electronic devices. Power may be supplied in accordance with user-defined preferences and information on device type, device status, device usage history, and other information. For example, a power adapter may preferentially supply power to device such as a wristwatch based on knowledge of the device type (wristwatch), based on battery status (the battery in the wristwatch is critically low), based on usage history (the wristwatch is typically used heavily in the evening so charging in the late afternoon is essential), based on user-defined charging priority settings (i.e., user preferences that give priority to, e.g., the user's wristwatch over, e.g., the user's cellular telephone), and/or based on other criteria. In this way, the power adapter can optimize the delivery of scarce power among multiple competing devices.

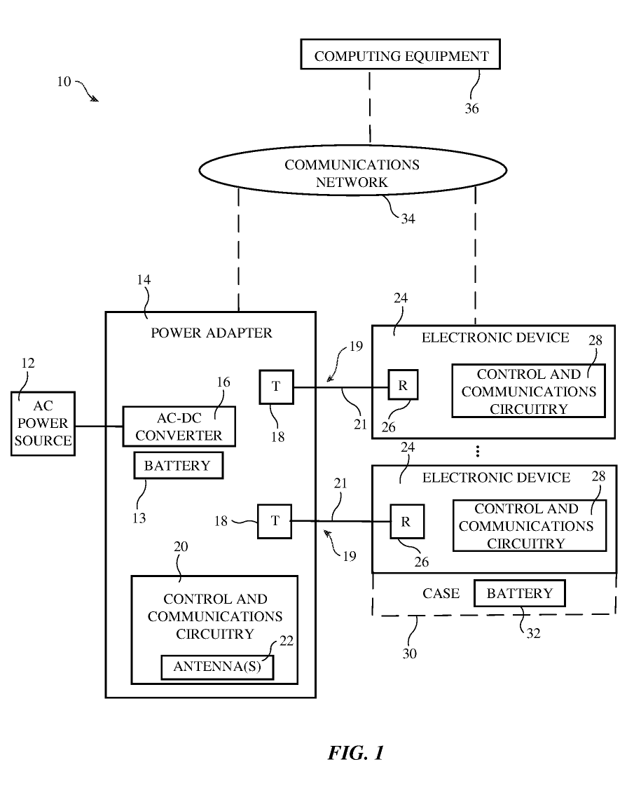

FIG. 1 is a diagram of a system with a power adapter that may supply power to multiple electronic devices. As shown in FIG. 1, system 10 may include a power adapter such as power adapter 14. Power adapter 14 may be coupled to a source of power such as alternating current (AC) power source 12. Power source 12 may be a wall outlet or other source of line power. If desired, power adapter 14 may receive direct current (DC) power from a source such as battery 13.

Power adapter 14 may include an AC-DC power converter such as converter 16. Converter 16 may convert AC power from source 12 into DC power. DC power from converter 16 and/or DC power from battery 13 may be distributed to circuitry within power adapter 14 such as power transmission circuits 18. Power transmission circuits 18 may be associated with respective power ports 19. Power ports 19 may supply power to corresponding electronic devices 24 via wired and/or wireless links 21.

Control and communications circuitry 20 may be used to control the operation of power transmission circuits 18. For example, circuitry 20 may be used to adjust the relative amounts of power supplied by first and second power transmission circuits 18 to first and second respective electronic devices 24 (e.g., so that the first electronic device receives more power from adapter 14 than the second electronic device or so that the second electronic device receives more power from adapter 14 than the first electronic device). If, for example, power adapter 14 has a maximum capacity of 40 W, 30 W of power may be allocated to the first device and 10 W may be allocated to the second device.

Circuitry 20 may include communications circuitry that communicates with electronic devices 24 over wired or wireless paths. For example, circuitry 20 may include wireless transceiver circuitry that is coupled to one or more antennas 22 for wirelessly transmitting and/or receiving signals. This allows circuitry 20 to receive information that is used in determining how to allocate power between devices 24.

Electronic devices 24 may include power reception circuits 26 for receiving power from respective power transmission circuits 18 over corresponding links 21. Control and communications circuitry 28 in devices 24 may be used to control the operation of devices 24 and may be used to communicate with external equipment. For example, communications circuitry in devices 24 may be used to communicate with communications circuitry in circuitry 20 of adapter 14 wirelessly or via wired paths. In some configurations, electronic devices 24 may be coupled to case such as case 30 (e.g., a cover, supplemental battery pack, or other accessory that has a battery such as battery 32 to provide an electronic device 24 with extra battery capacity).

Computing equipment 36 may include one or more servers or other computing equipment and may be coupled to power adapter 14 and/or electronic devices 24 via communications network 34. Communications network 34 may include one or more wired and/or wireless paths (e.g., internet links, local area network links, cellular telephone links, etc.). Equipment 36 may include communications circuitry for communicating with communications circuitry in power adapter 14 and devices 24. Equipment 36 may maintain online accounts for users of devices 24. A user may log into an online account using one of electronic devices 24 or other computing equipment (e.g., to adjust preferences, to register new electronic devices 24, etc.). During operation of devices 24, usage data (e.g., device usage history such as information on what time of day devices 24 are used and how much power is consumed as a function of time and date) and other information on the status and operation of devices 24 may be maintained in equipment 36 and/or may be communicated to other devices 24 and/or adapter 14. This information and other information may be used in system 10 to determine how much power should be provided to each of devices 24 over links 21.

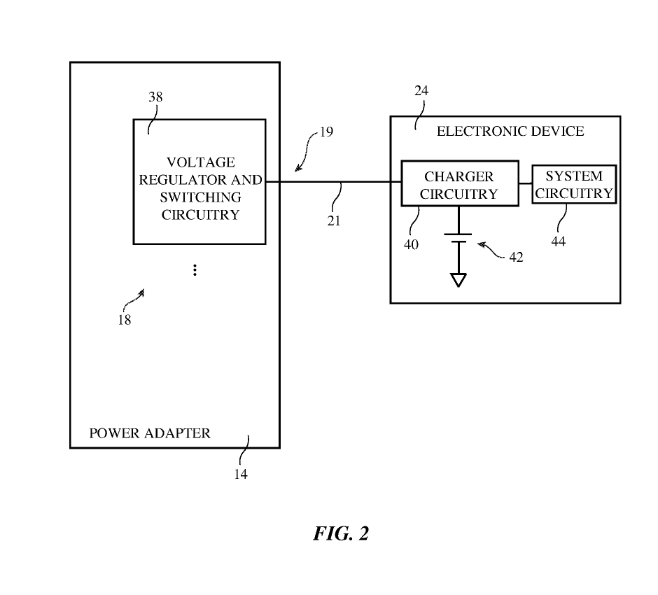

Power adapter 14 may have ports that supply wired power. As shown in FIG. 2, port 19 in power adapter 14 may have an associated wired power transfer circuit (18) with voltage regulator and switching circuitry 38. Voltage regulator and switching circuitry 38 may contain circuitry for controlling the current and voltage of power signals supplied to electronic device 24 over wired path 21. Electronic device 24 may have charger circuitry 40, battery 42, and system circuitry 44. Charger circuitry 40 may contain control circuits (e.g., switching circuitry, voltage regulator circuitry, etc.) for controlling the routing of power that has been received from path 21 to battery 42 and system circuitry 44. Battery 42 may be a rechargeable battery that is housed in a common housing with system circuitry 44 and, if desired, may be supplemented by an auxiliary battery (e.g., a battery in an external case such as battery 32 of case 30 of FIG. 1). When a battery (i.e., a battery such as battery 42 that is mounted in the housing of device 24 or an auxiliary battery coupled to device 24) is depleted, charger circuitry 40 may, if desired, route power from path 21 to the battery to charge the battery.

Charger circuitry 40 may also route power from path 21 to system circuitry 44 to power components in system circuitry 44. System circuitry 44 may include electrical components that provide device 24 with processing and input-output capabilities. For example, system circuitry 44 may include control circuitry such as microprocessors, memory, application-specific integrated circuits, communications circuitry, and other circuits, may include sensors, displays, keyboard, touch screens, and may include other input-output components that work in conjunction with the control circuitry, etc.

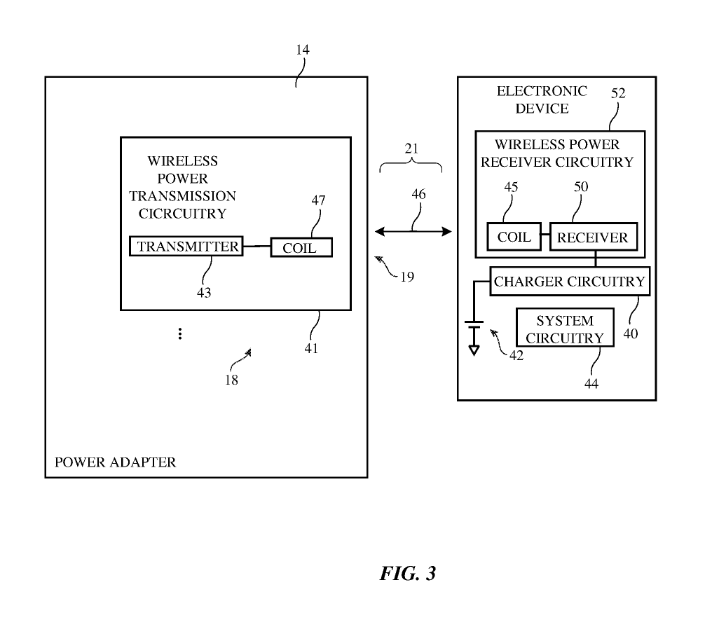

If desired, some or all of ports 19 may supply wireless power. As shown in FIG. 3, port 19 in power adapter 14 may have an associated power transfer circuit 18 based on wireless power transmission circuitry 41. Wireless power transmission circuitry 41 may include wireless power transmitter 43 (e.g., a transmitting circuit that produces alternating current signals) and an associated wireless power transmission device (antenna) such as coil 47. Wireless power may be transferred from power adapter 14 to device 24 using near-field and far-field techniques, may be transferred using microwave transmissions, may be transmitted using resonant inductive coupling, may be transmitted using capacitive coupling, or may be transmitted using other suitable techniques. In the illustrative example of FIG. 3, wireless power transmitter 43 is using wireless power transmission coil 47 (i.e., an inductor formed from one or more loops of wire or other signal paths) to transmit power wirelessly to device 24 via inductive charging

During inductive charging operations, transmitter 43 produces alternating current signals that are supplied to coil 47 and that cause coil 47 to produce electromagnetic signals 46 (alternating magnetic fields) that are conveyed to a corresponding wireless receiving element such as coil 45 in device 24 via path 21. Coils such as coils 47 may be arranged in an array (e.g., in a two-dimensional array of rows and columns of coils 47) or other suitable configuration (e.g., to incorporate coils 47 into an inductive charging mat that includes power adapter 14, to incorporate coils 47 into a housing of an electronic device such as a computer, to incorporate coils 47 into a bag, or to incorporate coils 47 into other equipment).

The use of inductive charging using an array of coils 47 (each of which may potentially supply wireless power to a respective device 24) is illustrative. Other types of wireless charging schemes may be used by adapter 14 to supply wireless power to device 24, if desired. The circuitry of adapter 14 may be housed in a single housing (e.g., a metal or plastic housing) and/or may be housed within multiple housings. As an example, part of adapter 14 may be housed in a cube-shaped enclosure and another part of adapter 14 (e.g., coils 47 and, if desired, associated transmitters 43) may be housed in another housing (e.g., a thin mat-shaped housing or other housing). A cable may be used to couple the coils and transmitter circuitry in the mat portion of this type of adapter to the main adapter unit.

As shown in FIG. 3, device 24 may include wireless power receiver circuitry 52. Wireless power receiver circuitry 52 may receive wireless power from adapter 14 and may use the receive power to charge an internal battery (e.g., battery 42) and/or a battery in a case that is coupled to device 24. Wireless power from adapter 14 may also be used to power system circuitry 44.

In the example of FIG. 3, wireless power is being transferred via inductive charging, so wireless power receiver circuitry 52 includes receiver 50 and coil 45 for receiving electromagnetic signals (magnetic fields) 46 from adapter 14. In other types of wireless charging schemes, coil 45 may be replaced with a capacitive electrode (e.g., in capacitive coupling wireless power schemes), may be replaced by a microwave antenna (e.g., in a far-field or near-field microwave wireless charging scheme), etc. The power received by coil 45 may be converted to DC power by receiver 50 and supplied to charger circuitry 40. Charger circuitry 40 may supply power to battery 42 to charge battery 42 and/or may supply power to system circuitry 44.

The maximum amount of power that adapter 14 can deliver over wired and wireless links 21 is limited. For example, adapter 14 may be rated to deliver 100 W of power, may be rated to deliver 50-150 W of power, may deliver a limited amount of power over 10 W of power, or may deliver less than 200 W of power. Because the ability of adapter 14 to supply power to devices 24 is limited, it is desirable to intelligently optimize the transfer of power to devices 24. User preferences, device usage history, battery state information and other device status information, and other information may be used in identifying an optimum power transfer strategy (e.g., an optimum charging strategy in scenarios in which each of devices 24 includes a battery to be charged). The circuitry of system 10 may be dynamically configured to implement the optimum power transfer strategy. The optimum power transfer strategy may favor one device over another so as to ensure that appropriate device(s) 24 have power. The power transfer strategy used by adapter 14 may, if desired, evolve over a period of time. For example, after critical charging operations that favor one device have been performed, power delivery settings for ports 19 may be adjusted to favor a different device and/or to balance power delivery among multiple devices.

A user may provide system 10 with user power transfer preferences using any suitable user input scheme. As an example, one or more of devices 24 may contain touch screen displays or other input devices. Control circuitry in devices 24 can use input-output circuitry in devices 24 to gather user input (e.g., by gathering responses to on-screen options, by gathering button press input, etc.). User input may also be supplied to equipment 36 (e.g., from a web browser). If desired, user input may be supplied to power adapter 14 using a touch screen, keyboard, buttons, voice command input interface, or other input-output circuitry in adapter 14. User input and other information that is gathered using devices 24, computing equipment 36, and/or adapter 14 may be stored in adapter 14, may be stored in device(s) 24, and/or may be stored in computing equipment 36.

As an example, device 24 may have a settings screen with which a user supplies device 24 with user-defined charging preferences (sometimes referred to as device charging priority information) or other power delivery settings. As another example, device 24 or other computing equipment may be used to log into an online account associated with computing equipment 36. Once logged into the account, the user may use a web browser or other interface to supply computing equipment 36 with power delivery preferences. As yet another example, adapter 14 may be used to gather power delivery preferences directly from a user or from device 24 and may store these preferences in control circuitry 20 of adapter 14.

Another potential source of information for use in identifying an optimum power delivery strategy is data that is stored in equipment such as adapter 14 and/or devices 24 by default. For example, device identifiers (device IDs) and other device information may be embedded into the circuitry of devices 24 during manufacturing. The device information may include serial numbers, model numbers, device type identifiers, device capability information (e.g., maximum charging power capabilities), and other device-specific information. By determining which type of device is being provided with power, power delivery may be further optimized (e.g., critical devices such as wristwatches may be favored over other devices such as media players). Device type information and other device-specific information may be gathered by adapter 14 from devices 24 (e.g., using wired and/or wireless links between adapter 14) and/or may be gathered by adapter 14 from devices 24 via computing equipment 36. Computing equipment 36 and devices 24 may also gather device type information and adapter type information from devices 24, equipment 36, and/or adapter 14.

The state of battery charge on the batteries used by devices 24 (e.g., internal batteries 42 and/or case batteries 32) may be used in determining charging priorities. For example, if the battery in a first device is nearly full and the battery in a second device is nearly empty, power may, at least initially, be delivered primarily to the second device. If desired, user preferences, device type, and other information may be used to override charging priorities based on battery state. For example, if a user has indicated that the first device is of primary importance or if the first device is of a type known to be critical (e.g., a wristwatch), the first device may be provided with power while the second device is provided with no power or less power (at least until the battery in the first device has been completely charged).

Another type of information that may be used in determining power delivery settings is device usage history information. A user may routinely deplete most of the battery of a device (e.g., a tablet computer) during an operating period extending from 3:00 to 5:30 PM on Mondays through Fridays (e.g., because this is a particular time of day and particular set of days during the week in which the user desires to watch video, play games, or perform other energy intensive tasks). The user may also routinely use another device (e.g., a wristwatch) upon waking at 7:00 AM every day of the week. Yet another device of the user (e.g., a cellular telephone) may be used primarily from 8 AM to 10 PM. The times at which the user is able to couple devices 24 to power adapter 14 to receive power may vary from day to day.

By collecting and maintaining device usage information for each of the user's devices 24 (e.g., a watch, cellular telephone, and tablet in this example), power delivery can be optimized among these devices. If, for example, the battery level of all devices is moderate and the devices are all coupled to adapter 14 at 2:00 PM, power delivery to the tablet computer (which is known to need extensive battery power from 3:00 to 5:30 PM) may be prioritized. Only after sufficient power has been provided to the tablet computer to charge the battery of the tablet computer sufficiently for the anticipated use of the tablet computer from 3:00 to 5:30 PM will significant power be routed to the wrist watch and cellular telephone. If, as another example, all devices are able to receive power from adapter 14 at 11:30 PM, adapter 14 may supply power to all of devices 14 equally, so that all devices are freshly charged overnight. Device usage history may, if desired, be used to prioritize power delivery to a first device (e.g., a tablet computer that is about to be used) over a second device (e.g., a cellular telephone) even if the battery of the first device is more charged than the battery of the second device. As with other types of information, user preferences may, if desired, be used to override power delivery priorities based on usage history information.

Links 21 may have different efficiencies. For example, wired power delivery links may be more efficient at delivering power (i.e., may deliver power with fewer parasitic losses) than wireless links. Links 21 may also have power delivery capacities that vary. For example, a first link may have a maximum power delivery rating of 10 W and a second link may have a maximum power delivery capability of 100 W. The charging circuits of devices 24 may also vary in efficiency between devices. In general, charging efficiency and capacity may be affected by the circuitry of adapter 14, the circuitry of devices 24, and/or environmental conditions (e.g., device placement in a wireless power scenario), causing different ports 19 of adapter 14 to be associated with different power transfer efficiencies.

Information on the capabilities of ports 19, links 21, and/or devices 24 (the power transfer efficiency of links 21 and/or the maximum rated charging power supported by devices 24) may be taken into account in optimizing power delivery. For example, even though it might otherwise be preferable to give preference to supplying power to a first device over a second device, power delivery to the second device may be given priority in scenarios in which power delivery through the adapter port associated with the first device is impaired (e.g., if link efficiency for the link associated with the first device is less than a predetermined threshold value, etc.). If desired, tests may be performed dynamically to evaluate power transfer efficiency. For example, the amount of battery charging that can be achieved for a given amount of power supplied to each port 19 may be measured by transferring trial amounts of power to devices 24 through each of ports 19 and a power delivery strategy may be optimized based on these battery charging characterization measurements. If for example, a particular battery has been prematurely aged due to exposure to high temperatures, it may be difficult to charge that battery efficiently and this information may therefore be taken into account in devising an optimum power transfer strategy.

In some situations, the systems of devices 24 may consume power during charging operations. As an example, a user may desire to use a tablet computer while the tablet computer is being powered using power from adapter 14 but may not need to power a display or otherwise actively use the systems in a wristwatch or cellular telephone that are coupled to adapter 14. In situations such as these, the devices that do not require significant system power (e.g., devices with inactive displays such as the wristwatch and cellular telephone in this example) may be supplied with less power than a device that has an active display (i.e., the tablet computer in this example). The optimization of the power delivery to devices 24 in this type of scenario may therefore take into account both battery charging requirements (based on battery state, usage history, device type, user preferences, etc.) and system usage requirements (as an example, adapter 14 may supply 1 W of power or less to devices with no active display and 10 W of power or more to devices with displays, wireless circuits, and/or processors that are actively being used by the user).

To prevent premature battery aging, it may be desirable to periodically allow the charge state of charged batteries to drop below 100%. For example, after a battery has been completely charged, it may be desirable to cease further charging until the battery charge level for the battery has dropped below 95% (or other suitable threshold value). This approach may be used, for example, to help preserve battery life. In some scenarios, battery charging strategy may be directed towards minimizing energy waste. For example, it may be desirable to charge a battery so that the battery reaches full charge right before a device is to be used. Battery charge state history information may therefore be used in conjunction with other battery information (e.g., current charge state, battery capacity, battery chemistry type, other battery type information, etc.) in determining how to optimize power delivery to devices 24 in system 10 (e.g., to preserve battery life, to minimize wasted energy, etc.). Battery charge state information may be gathered using circuitry in devices 24 such as charger circuitry 40. Other battery information may be stored in devices 24 during manufacturing (e.g., using a battery type identifier, etc.) or battery information may be obtained by using a database on computing equipment 36 or in adapter 14 to associate particular types of batteries with particular types of devices (which may be identified using a model number or other device information).

Devices 24 and other equipment (e.g., a user account maintained on remote computing equipment such as equipment 36 of FIG. 1) may maintain calendar information. Calendar entries in a calendar may be created by a user with a web browser or other user interface (e.g., user input arrangements associated with devices 24). Calendar information and other information that is gathered in system 10 may be used to predict future device usage. If, for example, a user is scheduled to be out of the office on a particular day, it may be concluded (as a default or by correlation with device usage history information) that the user will be traveling and will use a particular device (e.g., a cellular telephone) more than usual. When charging devices 24 in advance of the out-of-office period, more power may therefore be transferred to the cellular telephone than to other devices 24 to ensure that the cellular telephone is adequately charged.

Information on which software applications have been installed on devices 24 may also be used in predicting device power requirements. If, for example, a large number of power-intensive applications have been installed on a particular device, it can be concluded that the device has power requirements (i.e., battery reserve requirements) that are above average. As with the other information used in identifying an optimum power delivery strategy, information on which software applications have been installed on the control circuitry of devices 24 may be maintained on one or more of devices 24, on the control circuitry of adapter 14, and/or on control circuitry associated with remote equipment such as computing equipment 36.

In identifying an optimum power transfer strategy for adapter 14, power transfer optimization software may be run on the circuitry of adapter 14. For example, the circuitry of adapter 14 may be configured to gather information such as user preferences, usage history, device type, battery information, etc., and may be configured to identify how much power to provide to each of ports 19 (i.e., power transfer level settings for each of ports 19) so that optimum amounts of power are provided to each of devices 24 over links 21. If desired, circuitry in devices 24 and/or remote circuitry such as control circuitry in computing equipment 36 may be used instead of using circuitry in adapter 14 or may be used in conjunction with the circuitry of adapter 14 to identify an optimum power transfer strategy.

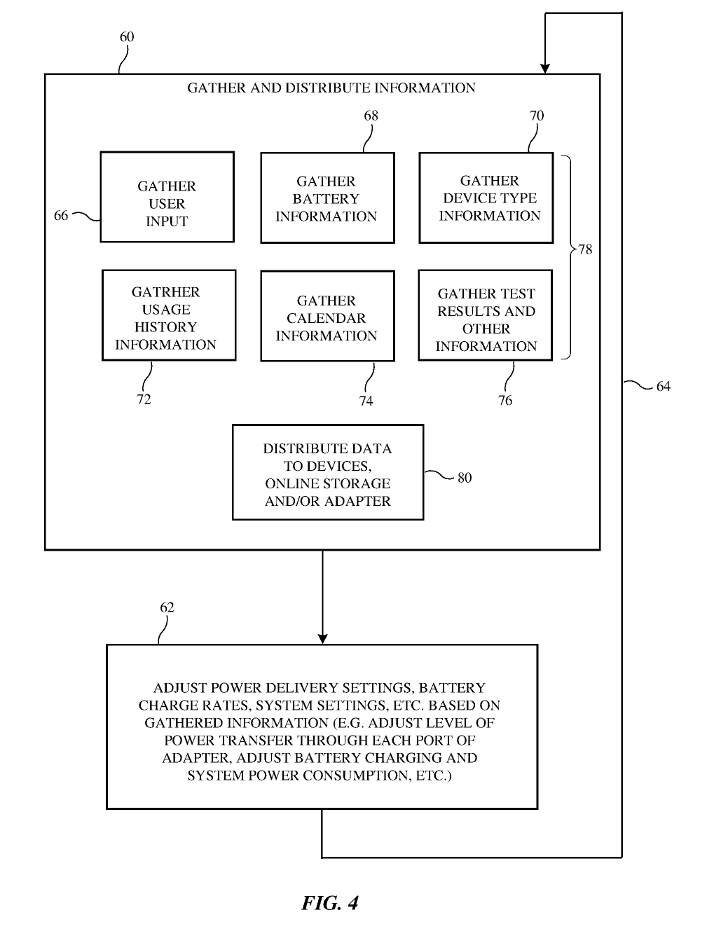

Illustrative operations involved in using system 10 to identify an optimum power transfer strategy for devices 24 and in using the strategy to supply power to devices 24 are shown in FIG. 4.

During the operations of block 60, information for use in identifying an optimum power transfer strategy may be collected using the equipment of system 10 (FIG. 1) and may be distributed throughout system 10. At step 62, the information that has been gathered at step 60 and/or other information may be used in identifying an optimum power delivery strategy that may be used by adapter 14 in transferring power to devices 24 via ports 19. As indicated by line 64, processing may then loop back to step 60 so that additional information for optimizing power delivery may be gathered.

Step 60 may include information gathering operations at step(s) 78 and data distribution operations at step 80. In general, information may be gathered using any of the resources of system 10 (e.g., information may be gathered using computing equipment 36, devices 24, and/or power adapter 14). As an example, each device 24 that is in communication with adapter 14 may, during the operations of step(s) 78, supply adapter 14 with information over a wired or wireless communication path between circuitry 28 in that device 24 and circuitry 20 in adapter 14 (e.g., links 21 or other links). Adapter 14 may gather information from computing equipment 36 via network 34.

If desired, user input may be gathered at step 66. User input may include user preferences such as user-defined device-type charging priorities, user-defined location-based charging priorities, user-defined charging priorities associated with particular times of day and/or for particular devices, or other user-defined power transfer settings. As an example, a user may specify that the user's watch should always be charged before the user's tablet computer, regardless of the state of charge on the watch or tablet. As another example, a user may set up more complex charging preferences (e.g., “charge my watch before my tablet so long as my tablet has at least a 25% battery charge level” or “charge my cellular telephone to 100% Sunday night before charging any other devices if my calendar indicates that I will be out of the office on Monday,” etc.). User preferences may be gathered using touch screens, keyboards, and other input-output circuitry (circuitry 28) on devices 24 and may be stored in devices 24. User preferences may also be gathered by computing equipment 36 (e.g., using a web browser on one of devices 24 or other electronic equipment that communicates with equipment 36 via communications network 34). Power adapter 14 may also have input-output devices (e.g., buttons, touch screens, or other input-output circuitry associated with control circuitry 20) for gathering user input.

At step 68, battery information may be gathered. Battery information may include a battery charge level (battery state) for the battery in each of devices 24 (and, if desired, information on the charge state of the battery in any associated cases such as case 30 of FIG. 1). In addition to gathering information on how much each battery is charged, information on battery health may be gathered (e.g., battery age, battery usage history, battery type, battery capacity in mAh, battery temperature, etc.).

At step 70, device type information may be gathered for devices 24. For example, a serial number, device identifier, device type identifier, model number, or other information identifying which types of devices 24 are present in system 10 and are available to receive power from adapter 14 may be gathered.

At step 72, device usage history information may be gathered. For example, information may be gathered on which applications are used in each of devices 24, information may be gathered on the power consumption of each of devices 24, information may be gathered on the battery charging history of devices 24, information may be gathered on screen brightness settings, wireless communications circuitry usage, other information on the use of components in devices 24 that consume significant amounts of power, and other information on the use of devices 24. Device usage information may include information on the time of day and date (e.g., day of week, day of month, etc.) associated with component usage (i.e., power consumption versus time/date information). Global positioning system data (i.e., satellite navigation system data gathered using circuitry 28 in devices 24) and/or other location information may be associated with component usage. For example, the device usage history information that is gathered at step 72 may indicate that a bright screen setting is routinely used for a device between 4 and 5 PM on weekdays, that wireless circuitry for web browsing and cellular telephone calls is used evenly throughout the week between 7 AM and 6 PM when the device is within 10 miles of the user's home and is used heavily between 6 AM and 9 PM when the device is more than 10 miles from the user's home, that charging typically takes place two or three times per week between 7 PM and 9 PM, and that media is played back by a media player application routinely at 3 PM each day, consuming significant power. Usage information may be correlated with device location, time and date information, device user identity information (e.g., when a given device is shared among multiple potential users), and other information.

At step 74, calendar information may be gathered. For example, a user may maintain a calendar on device(s) 24 and/or on online (e.g., on computing equipment 36). The entries in the calendar may include information on the user's future location (e.g., vacation or business meetings out of town, appointments in the user's hometown, etc.), may include information on the user's future activities (e.g., vacation may be correlated with heavy media playback activities, work may be associated with heavy wireless use, travel to bright locations at certain times of the year may involve the use of bright screen settings, etc.).

System 10 may perform tests and gather other information at step 76. As an example, adapter 14 may transfer default amounts of power to each of the devices that is coupled to adapter 14 to determine how effectively the batteries in the devices can be charged. These battery charging tests may reveal, for example, that some devices are relatively easy to charge (e.g., because the batteries in those devices are healthy, because the power transfer links to those devices and/or the circuitry at the transmit and receive ends of the links are efficient, etc.) and may reveal that other devices are relatively difficult to charge (e.g., because those devices have unhealthy batteries, are associated with poor link efficiencies, etc.). In addition to performing tests to ascertain link efficiency (battery charging efficiency) for each of ports 19 and each of the devices 24 coupled to ports 19, system 10 may periodically perform other tests and may be used in gathering additional data that may be used in developing an optimum power transfer strategy. Information that is gathered at step 76 and during the other operations of step 78 may be gathered continuously (e.g., whenever adapter 14, devices 24, and/or computing equipment 36 are running), may be gathered in accordance with a schedule (e.g., once per hour), may be gathered when suitable criteria (e.g., user-defined criteria and/or predetermined default criteria) have been satisfied, or may be gathered in accordance with any other suitable data gathering protocol.

During the operations of step 80, information that has been gathered in system 10 may be shared among the components of system 10. As an example, user device charging priority settings and other user preferences that have been gathered during user interactions with an online account maintained by computing equipment 36, calendar data, and other data may be transferred to power adapter 14 from computing equipment 36. As another example, calendar information, battery charge state information, device usage information, user preferences, device type, and other information that has been gathered during a user's interactions with devices 24 may be transferred from devices 24 to power adapter 14. Information may also be shared between devices 24 and computing equipment 36 (e.g., by synching calendar data between devices 24 and computing equipment 36, by uploading device usage history from devices 24 to computing equipment 36 to reduce storage burdens on devices 24, etc.). If desired, adapter 14 may transfer information to devices 24 and/or computing equipment 36 (e.g., information on device charging preferences that a user supplied directly to adapter 14 may be provided to an online account on equipment 36 and/or to a user preferences application running on devices 24). These techniques for sharing information between the devices in system 10 are illustrative. Other types of information sharing arrangements may also be used, if desired.

At step 62, system 10 may process the information gathered at step 60 and other information (e.g., information on the current time and date, information on the current locations of the devices in system 10, etc.) to identify optimum power transfer settings for adapter 14 to use in transferring power to devices 24 through ports 19. In determining which power transfer settings to use (i.e., in determining how many watts of power to transfer over each of lines 21 and therefore how much power to use in charging each of devices 24), the processing circuitry of power adapter 14 (and/or processing circuitry in devices 24 and/or computing equipment 36) may take into consideration competing desires. For example, it may generally be desirable to give charging preference to those devices 24 that have heavily depleted batteries, as this will help prevent scenarios in which one or more of devices 24 become unusable due to lack of battery power. Nevertheless, user device charging priority information or considerations based on device history usage, device type, link efficiency, predictions based on calendar information, test results, or other information may make it beneficial to override this general desire. If, as one example, a first of devices 24 is a critical device such as a watch and a second of devices 24 is a less critical device such as a media player, it may be desirable to preferentially charge the first device. This type of consideration, which is based on device type information, may be overridden by user preferences that specify that charging priority should be given to the media player over the watch.

Adapter 14 or other equipment in system 10 may be used to weigh these competing demands and identify an optimum power transfer strategy. For example, adapter 14 may analyze factors such as user preferences (e.g., priority settings that specify desired priorities for charging devices 24), battery information (battery health, battery capacity, battery charge level, etc.), device type (e.g., media player, cellular telephone, watch, laptop computer, tablet, etc.), device charging capabilities (e.g., the maximum rated charging power supported by each device), device usage history information (e.g. information on power consumption levels correlated with time of day, day of week, device location, device user, and other device usage history information), calendar information, and test results and other information. In analyzing these factors, adapter 14 may use weighting schemes and other decision algorithms techniques in determining how much power to transmit through each of ports 19 (i.e., how much power to transfer to each of devices 24). Adapter 14 may then adjust the settings of power transfer circuits 18 (and, if desired, may direct devices 24 to adjust power receiving circuits 26 and/or other device components such as charger circuitry 40, system circuitry 44, etc.) so that appropriate amounts of power are transferred to each of devices 24 over links 21 to operate the system circuitry in each of devices 24 and/or to charge the batteries in each of devices 24. The amounts of power that are transferred may be less than the maximum rated charging power supported by each device, may favor a second device over a first device based on user charging preferences or other information (e.g., so that the second device receives its maximum rated charging power and so that the first device receives less than its maximum rated charging power), may sometimes cause less fully charged devices to be provided with more power than devices that are more fully charged, may sometimes cause less fully charged devices to be provided with less power than devices that are more fully charged, may sometimes provide electronic devices with amounts of power that are based on device type rather than user preferences, may sometimes provide electronic devices with amounts of power that are based on user preferences rather than device type, may sometimes provide electronic devices with amounts of power that are based on multiple weighted factors such device type, user preferences, calendar information, and other information, etc.

The operations of FIG. 4 may be performed by the control circuitry in adapter 14, in devices 24, and/or in computing equipment 36. During operation, this control circuitry (which may sometimes be referred to as processing circuitry, processing and storage, computing equipment, a computer, etc.) may be configured to perform the methods of FIG. 4 (e.g., using dedicated hardware and/or using software code running on hardware in adapter 14, devices 24, and/or computing equipment 36). The software code for performing these methods, which may sometimes be referred to as program instructions, code, data, instructions, or software, may be stored on non-transient (tangible) storage media in the control circuitry of adapter 14, devices 24, and/or computing equipment 36 such as read-only memory, random-access memory, hard drive storage, flash drive storage, removable storage medium, or other computer-readable media and may be executed on processing circuitry such as microprocessors and/or application-specific integrated circuits with processing circuits in the control circuitry of adapter 14, devices 24, and/or computing equipment 36 to perform the processes of FIG. 4.

The foregoing is merely illustrative and various modifications can be made to the described embodiments. The foregoing embodiments may be implemented individually or in any combination.

What is claimed is:

1. A power adapter configured to supply power from a power source to electronic devices, comprising:
power transfer circuitry that is configured to supply power to a plurality of electronic devices over respective power transfer links;
communications circuitry that is configured to receive information from the plurality of electronic devices including device usage history information; and
control circuitry that is configured to direct the power transfer circuitry to transfer power to at least one of the electronic devices over at least one of the respective power transfer links in an amount that is based at least partly on the device usage history information.

2. The power adapter defined in claim 1 further comprising:
an alternating-current-to-direct-current converter that is configured to receive alternating-current power from the alternating-current power source and that is configured to supply power to the power transfer circuitry, wherein the information from the plurality of electronic devices further comprises battery charge state information and device identifier information and wherein the control circuitry is further configured to direct the power transfer circuitry to transfer the power to the at least one of the electronic devices over the at least one of the respective power transfer links in an amount that is based at least partly on the battery charge state information and device identifier information.

3. The power adapter defined in claim 2 wherein the power transfer circuitry comprises a plurality of power transfer circuits each of which is configured to supply power to a respective one of the electronic devices.

4. The power adapter defined in claim 3 wherein the power transfer links include at least one wired link that is coupled to at least one of the electronic devices and wherein the power transfer circuitry comprises a wired power transfer circuit coupled to the wired link.

5. The power adapter defined in claim 3 wherein the power transfer links include at least one wireless power transfer link and wherein the power transfer circuitry includes a wireless power transmitter that is coupled to a coil that is configured to wirelessly transmit power over the wireless power transfer link.

6. The power adapter defined in claim 2 wherein the power transfer circuitry comprises a plurality of transmitters coupled to a plurality of respective coils.

7. The power adapter defined in claim 6 wherein the communications circuitry comprises wireless communications circuitry.

8. The power adapter defined in claim 7 wherein the information includes battery charging test results gathered by supplying power to the electronic devices and wherein the control circuitry is further configured to direct the power transfer circuitry to transfer power to the at least one of the electronic devices over the at least one of the respective power transfer links in an amount that is based at least partly on the battery charging test results.

9. The power adapter defined in claim 7 wherein the information includes device charging priority information from a user of the electronic devices and wherein the control circuitry is further configured to direct the power transfer circuitry to transfer power to the at least one of the electronic devices over the at least one of the respective power transfer links in an amount that is based at least partly on the device charging priority information.

10. A method of prioritizing wireless charging of batteries in electronic devices, comprising:
with control circuitry in a power adapter having wireless power transmitter circuitry coupled to a plurality of wireless power transmitters and associated wireless charging coils, gathering information that includes battery charge state information for each of the batteries, device type for each of the electronic devices, and user device charging priority information for the electronic devices; and
with the control circuitry, directing the wireless power transmitters and associated wireless charging coils to supply different amounts of power to each of the electronic devices based on the gathered information.

11. The method defined in claim 10, wherein the supplied amounts of power comprise a first amount of power for a first electronic device of the electronic devices and wherein the first amount of power is less than a maximum rated charging power supported by the first device.

12. The method defined in claim 10, wherein the supplied amounts of power comprise a second amount of power for a second electronic device of the electronic devices and wherein the second amount of power is a maximum rated charging power supported by the second device.

13. The method defined in claim 10, wherein directing the wireless power transmitters and associated wireless charging coils to supply different amounts of power comprises:
in accordance with a determination, based at least in part on the user device charging priority information, that a user prefers to charge a first electronic device over a second electronic device, supplying a higher amount of power to the first electronic device than the second electronic device, wherein the first electronic device has a higher battery state-of-charge than the second electronic device.

14. The method defined in claim 10 wherein gathering the information comprises gathering calendar information and wherein directing the wireless power transmitters and associated wireless charging coils to supply different amounts of power to each of the electronic devices comprises directing the wireless power transmitters and associated wireless charging coils to supply different amounts of power to each of the electronic devices based at least partly on the calendar information.

15. The method defined in claim 10 wherein gathering the information comprises gathering device usage history information and wherein directing the wireless power transmitters and associated wireless charging coils to supply different amounts of power to each of the electronic devices comprises directing the wireless power transmitters and associated wireless charging coils to supply different amounts of power to each of the electronic devices based at least partly on the device usage history information.

16. The method defined in claim 15 wherein the device usage history information includes historical information on device power consumption at different times of day.

17. Apparatus that is configured to provide power to a plurality of electronic devices each of which has a battery and each of which has communications circuitry that is configured to transmit battery charge state information for the battery and device type identification information, comprising:
circuitry that is configured to receive power from a power source; and
circuitry that is configured to receive the transmitted battery charge state information and device type identification information from the plurality of electronic devices, wherein the circuitry is configured to supply each of a plurality of electronic devices with the power in respective amounts that are based at least partly on the battery charge state information and device type identification information.

18. The apparatus defined in claim 17 wherein the circuitry that is configured to receive the power from the power source comprises an alternating-current-to-direct-current converter that receives alternating-current power and wherein the circuitry that is configured to receive the transmitted battery charge state information and device type identification information comprises a plurality of wireless power transmitters and a plurality of corresponding wireless power transmission coils that are configured to wirelessly supply the power to the plurality of electronic devices.

19. The apparatus defined in claim 18 wherein the circuitry that is configured to receive the transmitted battery charge state information and device type identification information is further configured to receive device usage information from the plurality of electronic devices, wherein the device usage information includes information on power consumption for each of the electronic devices over multiple days of a week, and wherein the plurality of wireless power transmitters and the plurality of corresponding wireless power transmission coils are configured to wirelessly supply the power to the plurality of electronic devices based at least partly on the device usage information.

20. The apparatus defined in claim 19 wherein the circuitry that is configured to receive the transmitted battery charge state information and device type identification information is further configured to receive calendar information, wherein the calendar information includes information on calendar entries for a user of the electronic devices, and wherein the plurality of wireless power transmitters and the plurality of corresponding wireless power transmission coils are configured to wirelessly supply the power to the plurality of electronic devices based at least partly on the calendar information.

21. A non-transitory computer readable storage medium, comprising instructions for:
gathering battery charge state information at a power adapter for batteries in electronic devices that communicate with the power adapter;
gathering user device charging priority information for the electronic devices at the power adapter; and
directing wireless power transmitters and associated wireless charging coils at the power adapter to wirelessly supply different amounts of power to each of the electronic devices based on the battery charge state information and the user device charging priority information.
